(19) United States
(12) Patent Application Publication
(10) Pub. No.: US 2009/0218459 A1
(43) Pub. Date: Sep. 3, 2009

(54) Device for Fixing a Module on the Inner Wall of a Tire

(75) Inventors: Pierre Durif, Enval (FR); Xavier Paul, Chamallers (FR)

Correspondence Address: COHEN, PONTANI, LIEBERMAN & PAVANE LLP, 551 FIFTH AVENUE, SUITE 1210, NEW YORK, NY, 10176, US

(73) Assignee: Michelin Recherche et Technique S.A., Granges-Paccot (CH)

(21) Appl. No.: 12/296,220

(22) PCT Filed: Mar. 30, 2007
(86) PCT No.: PCT/EP2007/053108

§ 371 Date: May 18, 2009

(30) Foreign Application Priority Data
Apr. 4, 2006 (FR) 0603077

(51) Int. Cl. F16M 13/02

(52) U.S. Cl. 248/205.1

(57) ABSTRACT

A device for fixing a module to the internal wall of a tire. The device includes a support secured to the tire, the support having at least two independent straps secured to the support and means for immobilizing the module, the straps being oriented radially.

The invention relates to a device for fixing a module to the internal wall of a tire and more specifically to a device for fixing an electronic module.

The use of electronic modules in tires may provide a multitude of applications consisting in acquiring, storing and/or transmitting information for the purpose of monitoring the use of the tire and especially providing information about the evolution in performance of the tire during its lifetime.

Such electronic modules may comprise passive components, such as identification or RFID chips, and/or active components which are connected to an autonomous power supply system, such as batteries or else an inductive coupling system. These electronic modules may be designed to exchange information with external modules, serving for example as a user interface, by means of radio waves, the frequency and power of which are carefully adjusted in accordance with specific transmission protocols. They may also be designed to store information, so as to be interrogated subsequently, for example for analyzing the wear of the tire. The electronic modules are generally placed inside flexible or rigid protective cases intended to preserve the electronic components from being subjected to shocks and from the ambient atmosphere in the tire, especially owing to the presence of a fluid for, for example, anti-oxidation or anti-puncture purposes, and from its environment.

Such an electronic module may in particular be fixed to the inside of the cavity formed by the tire once this has been fitted on to a wheel. To do this, it may be placed on a large number of supports. Thus, it may be fixed to the valve, fixed to the rim, fixed or bonded to the inner wall of the tire or else incorporated into the components of the tire. The selection of one of these solutions depends on the nature of the tire, on the stresses that it may undergo, on the nature of the energy source for the electronic module, on the information that it is desired to monitor and on the desired accessibility in the case of maintenance. The invention relates to the case of an electronic module fixed to the internal wall of the tire.

When the electronic module is thus joined to the tire, the selected fixing mode must ensure that the module is held in position whatever the rotation speed and the usage conditions of the tire.

Fixing solutions meeting these requirements have already been described, for example in the publications EP 0 936 089, U.S. Pat. No. 6,255,940, U.S. Pat. No. 6,462,650 or WO 2005/044600, which describe systems for fixing a module to the inner wall of a tire. These devices are made up of a flexible support, one face of which serves for joining to the inner wall of the tire and the other face of which has fixing means that cooperate with the attachment means placed on the module.

Although not limited to this type of application, the invention will be more particularly described with reference to electronic modules with a length of 12 cm or greater, which are intended to be inserted into tires for vehicles of the civil engineering type that have an axial width greater than 18 inches and possibly up to 63 inches in the case of dumper-type vehicles.

In the case of this type of vehicle, especially intended for being used in mines or quarries for transporting loads, the dimensions of the tires associated with the loads that they support on rolling lead to deflections of the tires of around 20 to 30% depending on the size of the tire. They may in particular undergo load increases in excess of 50% owing to dynamic overloads associated for example with braking in the case of loader-type vehicles or else, for example, with deformation of the paths on which dumper-type vehicles have to run.

The deflection of a tire is defined by the radial deformation of the tire, or a change in radial height, when said tire passes from an unloaded state to a statically loaded state under nominal load and pressure conditions.

It is expressed in the form of a relative deflection, defined by the ratio of this change in radial height of the tire to one half of the difference between the outside diameter of the tire and the maximum diameter of the rim measured on the gutter. The outside diameter of the tire is measured statically in the unloaded state under nominal pressure.

The tire is thus subjected to radial stresses in this zone. These stresses are combined with longitudinal stresses, in particular because of the deradialization of the tire in the zone of the contact area. The combination of these stresses results in particular in deformations of the tire walls.

These deformations combined with the presence of electronic modules such as those mentioned above the length of which is relatively large, require fixing means that are more adapted to guaranteeing the longevity of the fixing. Furthermore, it is usual to position such modules in these zones of the tire, in order to avoid the crown zone, so as to limit as far as possible any malfunction, or interference, due to the presence of the metal reinforcing elements of the crown reinforcement. Only the metal reinforcing elements of the carcass reinforcement may interfere with the proper operation of said modules fixed in these zones.

The inventors were thus given the task of defining a device for fixing an electronic module that ensures the longevity of said fixing, including in the case of a module as described above having a length of at least 12 cm, this being fixed in a tire that may undergo deflections of around 30% and being positioned so as to minimize the interference due to the presence of the metal reinforcements.

This objective was achieved according to the invention by a device for fixing a module to the internal wall of a tire, said device consisting of a support secured to the tire, the support having at least two independent straps secured to the support and means for immobilizing the module, the straps being oriented radially.

In the invention, the radial orientation of the straps means that the principal direction of the strap is radial and therefore parallel to the reinforcing elements of the carcass reinforcement.

Advantageously, to minimize the interference on account of the reinforcing elements of the crown reinforcement, the support is located in the sidewall of the tire and more preferably in the lower part of the sidewall.

In accordance with the invention, the support fixed to the internal wall of the tire is associated with two straps, each providing part of the fixing and part of the immobilization of the module. This distribution of the fixing and immobilizing forces between at least two independent means is particularly advantageous in the case of a module of relatively large length. This is because the fixings for such modules are highly stressed when said modules are fixed in parts of the tire, such as the sidewalls, which are subjected to frequent high stresses owing to the deformations of the tire as it rolls. The use of two independent fixing means separated from each other makes it possible to retain the module while limiting the stresses that are exerted on it when the fixing means themselves are stressed owing to the deformations. In contrast, the presence of a single means, necessarily of larger dimensions so as to provide the same retention, runs a much higher risk of the module being damaged, the stresses that are exerted on it being more localized.

According to one particularly advantageous embodiment of the invention, a fixing means consists of a strap secured to the support. This strap secured to the support is preferably made at the same time as the support is produced. It may be obtained by two openings made in the thickness of the support; these openings thus forming the straps can be likened to a passageway for passage of the module. This embodiment is particularly advantageous owing to its simplicity of construction and to its use. The openings in the support may for example be made during manufacture of said support. When the latter is made of a polymeric material, such as rubber, during its crosslinking or vulcanization, an insert is provided to which the rubber does not adhere, this insert then being removed so as to reveal two openings forming a passageway.

A constructional variant of the invention provides for the module to include at least one complementary means for fixing and/or immobilizing said module.

According to a first embodiment of this variant of the invention, the complementary means for fixing and/or immobilizing the module is an appendage that complements an opening provided in the thickness of the strap, said appendage being set into this opening when the module is slid beneath the strap.

Such a complementary fixing may furthermore allow the module to be centered with respect to a predefined position and also contribute to immobilizing the module, in particular preventing any risk of the module slipping.

In a second embodiment of this variant of the invention, the complementary means for fixing and/or immobilizing the module is a feature provided on the surface of the module of the notch type against which the strap butts when the module is in place beneath said strap. Once the module is in place, the feature provided on the module prevents the module from moving by sliding, said feature butting against the strap. Such an embodiment makes it possible in particular to limit the deformation and prevent the detachment of the module when the tire is subjected to large deformations.

According to a preferred embodiment of the invention, the module is immobilized by forces exerted by the fixing means.

According to a first embodiment, the forces exerted by the fixing means are elastic restoring forces. According to this embodiment, the module is immobilized once said module has been attached.

According to a second embodiment, the forces exerted by the fixing means are obtained by the thermal contraction of said fixing means. To do this, the fixing means are advantageously made of a suitable material and are heated once the module has been attached.

A preferred constructional variant of the invention also provides for the support to be made of a polymeric material crosslinked on the tire. Also advantageously, the support is crosslinked simultaneously with the crosslinking, especially vulcanization, of the tire. According to this constructional variant of the invention, the manufacture of the tire having a support is carried out more rapidly and the fixing of the support is perfectly secured to the internal wall of the tire.

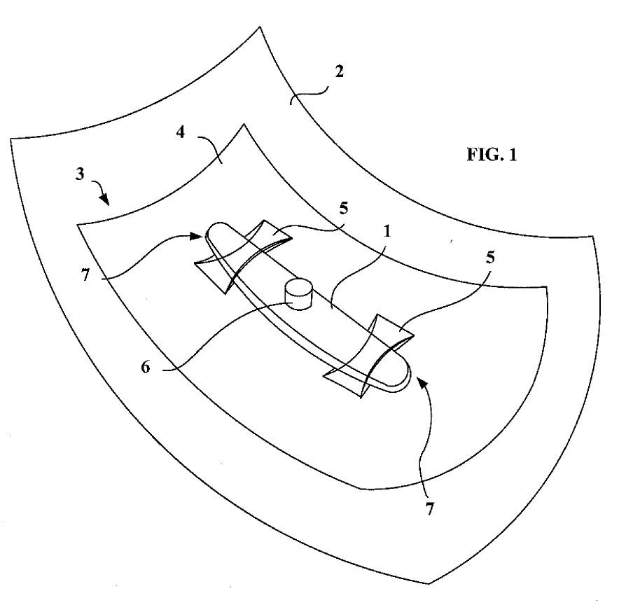

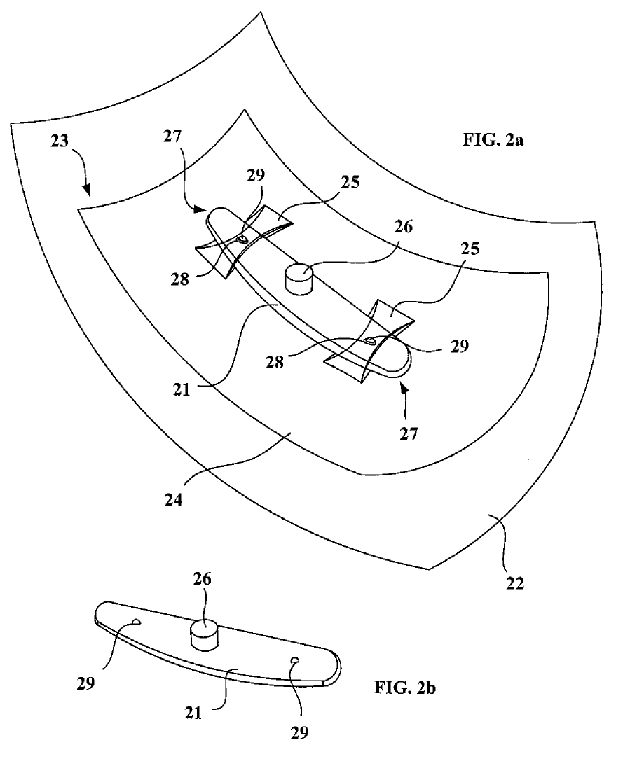

Other details and advantageous characteristics of the invention will emerge below from the description of exemplary embodiments of the invention with reference to FIGS. 1 and 2 which show:

FIG. 1, a schematic representation according to a first embodiment of a device according to the invention; and

FIGS. 2a, 2b, a schematic representation according to a second embodiment of a device according to the invention.

The figures have not been drawn to scale in order to make them easier to understand.

FIG. 1 shows an electronic module 1 fixed to the internal wall 2 of a tire using a fixing device 3. The fixing device 3 is itself made of a support 4 secured to the tire, said support being provided with two straps 5 beneath which the electronic module 1 is inserted.

The support 4 may, for example, be produced when building the tire, one or more rubber layers constituting it being put into place and then cured simultaneously with the curing of the tire. The two straps 5 may be formed by the presence of elements put into place during curing. Such elements are made of any material known to those skilled in the art to which rubber does not adhere, which elements are inserted between two rubber layers and the ends of which are positioned so as to form the two straps in the desired manner.

According to another embodiment, the support 4 may be made of rubber by prior molding and attached to the tire before the latter is cured. The support 4 is then already cured and the bonding obtained by interposing an interface between the support 4 and the tire, enabling bonding to be achieved between support and tire while the latter is being cured.

According to a last embodiment, the support 4 may be made of rubber by prior molding, but this undergoes only partial curing enabling the base, i.e. that part of the support intended to come into contact with the tire, to remain uncrosslinked. The support thus obtained is placed on the tire before the latter is cured and the bonding between support and tire is thus achieved when curing the tire. According to this embodiment, it is however prudent to limit the preservation time of the prefabricated and partially crosslinked supports.

The support 4 is advantageously made of unreinforced rubber so as to better withstand all the deformations of the tire. However, if reinforcing elements have to be present, these are advantageously elastic reinforcing elements.

The straps 5 are also made of unreinforced rubber so as to better withstand the deformations of the tire.

The electronic module 1 has a measurement head 6, for example for pressure measurement, on top of it. To ensure undisturbed measurements, it is preferable for the measurement head 6 not to be covered by the straps 5. Since the two straps are independent of each other it is easily possible to fix the module without covering the measurement head 6 of the electronic module 1. It is also advantageous for the two straps to be relatively far apart and close to the end 7 of the module 1 in order to ensure that the module is attached whatever the deformations undergone by the tire.

The straps 5 made of unreinforced rubber advantageously have elastic properties that are sufficient to immobilize the electronic module 1. Rolling trials have actually shown that, when the tire is subjected to large stresses due to the deformations on it passing over stony ground, the electronic module remains in place and the fixing device is undamaged.

FIG. 2a illustrates a constructional variant in which the two straps 25 have two openings 28, for example circular openings, approximately at the centre of each respective strap.

These openings 28 are complementary to two appendages or lugs 29, shown in FIGS. 2a and 2b, which are provided on the electronic module 21. When the latter is slid beneath the straps in order to be retained thereby, the two appendages 29 slip into the openings 28 of the straps 25. Such a constructional variant has various advantages. Firstly, the presence of these openings 28 and appendages 29 allows the electronic module 21 to be installed in a perfectly defined position. Secondly, this combination of openings 28 and appendages 29 helps immobilize the electronic module 21, in particular avoiding any risk of it slipping.

Other constructional variants of the invention (not shown in the figures) also provide for bonding the straps to the electronic module. When the module is slid beneath the straps, provision is made for the inner face of the straps to be simultaneously bonded to the covered parts of the module. To do this, adhesive is deposited on one of the elements to be bonded—either strap or module—just before the step of placing the module beneath the straps. Such bonding may, in particular, contribute to immobilizing the module.

Bonding the straps to the module may also allow the system to be made tamper-proof since certain uses of such electronic modules require the information measured by the module to be recovered during a tire change. Such an operation may for example allow the use of the tire, or at least the change in some of its parameters, to be at least partially retraced. It may therefore in fact be desirable to make any intervention on said electronic measurement module impossible or at the very least detectable. In the case of bonding, an attempt to change the electronic module, or its change, will be made visible by traces of tearing, either on the module or on one or both straps.

This constructional variant of the invention in which bonding is involved may be combined with one or other of the embodiments of the invention described in FIGS. 1 and 2.

Tests were carried out with tires of 18.00R33 and 33.00R51 size to which modules of the pressure sensor type, with external dimensions of 17 cm in length, 3.5 cm in width and 0.9 cm in thickness, were fixed.

These modules were fixed using a device as described in FIG. 1, the support being fixed to the internal wall of the tire during manufacture of the latter. Since the support was made of rubber, it was vulcanized simultaneously with the tire. The module was then fixed by insertion beneath the two straps.

Rolling trials were carried out so as to simulate use on vehicles traveling in mines.

The results obtained made it possible to confirm the effectiveness of the fixing device according to the invention, in particular in terms of retention over the course of time when rolling.

1. A device for fixing a module to the internal wall of a tire, comprising a support secured to the tire, wherein the support has at least two independent straps secured to the support and means for immobilizing the module, and wherein the straps are oriented radially.

2. The fixing device according to claim 1, wherein at least one strap includes a complementary means for fixing the module.

3. The fixing device according to claim 2, wherein the complementary means for fixing the module is an opening provided in the thickness of the strap.

4. The fixing device according to claim 1, wherein the module is immobilized by forces exerted by the fixing means.

5. The fixing device according to claim 4, wherein the forces exerted by the fixing means are elastic restoring forces.

6. The fixing device according to claim 4, wherein the forces exerted by the fixing means are obtained by the thermal contraction of said fixing means.

7. The fixing device according to claim 1, wherein the support is made of a polymeric material crosslinked on the tire.
